(19) United States
(12) Patent Application Publication
(10) Pub. No.: US 2006/0222435 A1
(43) Pub. Date: Oct. 5, 2006

(54) Cover locking apparatus for a multi-function device

(75) Inventors: Dong-Woo Ha, Suwon-si (KR); Sung-Wook Kang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/360,466

(22) Filed: Feb. 24, 2006

(30) Foreign Application Priority Data
Apr. 4, 2005 (KR) 2005-0027941

(51) Int. Cl. B41J 29/02

(52) U.S. Cl. 400/691

(57) ABSTRACT

The present invention relates to a multi-function device comprising a printer, a scanner coupled to the printer to move between an opened and closed position with respect to the printer, and a scanner cover for the scanner. An unlocking part is located on the printer. The scanner has a stopper accommodator that vertically penetrates the scanner at a position that corresponds to the unlocking part. A locking part is located on the scanner cover at a position that corresponds to the position of the stopper accommodator. A stopper is movably accommodated in the stopper accommodator and has a first end and a second end. The first end of the stopper contacts the unlocking part and the second end contacts the locking part. The stopper moves between a locked position in which the second end engages the locking part to prevent the scanner cover from being opened when the scanner is opened with respect to the upper surface of the printer, and an unlocked position in which the unlocking part presses the first end of the stopper to allow the scanner cover to be opened. Thus, the present invention provides a multi-function device which controls the opening and closing of a scanner cover corresponding to the opening and closing of a printer by a scanner.

### CROSS-REFERENCE TO RELATED APPLICATIONS

This application claims the benefit under ˜35 U.S.C. § 119(a) of Korean Patent Application No. 2005-0027941, filed on Apr. 4, 2005, in the Korean Intellectual Property Office, the entire disclosure of which is hereby incorporated by reference.

### BACKGROUND OF THE INVENTION

1. Field of the Invention

The present invention relates to a multi-function device comprising a printer, a scanner, and a scanner cover. More particularly, the present invention relates to a device that locks and unlocks the scanner cover so that it can be opened and closed depending on whether the scanner is opened or closed with respect to the printer.

2. Description of the Related Art

A multi-function device is a single device that performs various operations such as photocopying, printing, faxing, scanning, and the like. Multi-function devices are widely used because of their cost-effectiveness, their convenience, and because they occupy less space than separate, individual devices.

FIGS. 1 and 2 are schematic views of a conventional multi-function device. As shown there, a multi-function device 100 comprises a printer 110 and a scanner 120. The printer 110 forms an image through a printer head (in an inkjet printer) or an image forming unit (in a laser printer). The scanner 120 scans an image.

The scanner 120 is coupled to an upper part of the printer 110 by a first hinge 112 so that the scanner can be opened and closed with respect to an upper surface of the printer 110. A scanner cover 130 is coupled to the scanner 120 by a second hinge 122 so that it can be opened and closed with respect to an upper surface of the scanner 120.

While being used, the scanner 120 closes the printer 110, and the scanner cover 130 is easily opened and closed. If maintenance needs to be performed on the printer 110 (such as replacing a cartridge or clearing a paper jam), the scanner 120 pivots to open the printer 110.

In the conventional multi-function device 100, the scanner cover 130 may open when the scanner 120 pivots to open the printer 110. In particular, if the upper part of the scanner cover 130 has an upper unit 160 (such as an automatic paper feeding unit), the weight of the upper unit 160 may cause the scanner cover 130 and the upper unit 160 to fall open when the scanner 120 is pivoted. If this happens, the pivoting of the scanner cover 130 and the upper unit 160 cause the conventional multi-function device 100 to incline towards one side, thereby becoming unstable and potentially falling down.

Accordingly, there is a need for a multi-function device with an improved scanner cover.

### SUMMARY OF THE INVENTION

An aspect of the present invention is to solve at least the above problems and/or disadvantages and to provide at least the advantages described below. Accordingly, an aspect of the present invention is to provide a multi-function device that controls the ability to open and close a scanner cover. That is, the multi-function device prevents the scanner cover from opening when the scanner is opened with respect to the printer, and allows the scanner cover to open when the scanner is closed with respect to the printer.

Additional aspects and/or advantages of the invention will be set forth in part in the description which follows and, in part, will be obvious from the description, or may be learned by practicing the invention.

In an exemplary embodiment of the invention, a multi-function device comprises a printer, a scanner, and a scanner cover. The printer has an unlocking part. The scanner is coupled to the printer to move between opened and closed positions with respect to an upper surface of the printer. A stopper accommodator penetrates the scanner at a position corresponding to the position of the unlocking part on the printer. The scanner cover is coupled to the scanner to move between opened and closed positions with respect to an upper surface of the scanner. The scanner cover has a locking part at a position that corresponds to the position of the stopper accommodator. The stopper is movably accommodated in the stopper accommodator to move between a locked position and an unlocked position. In a locked position, a second end of the stopper is locked into the locking part to prevent the scanner cover from being opened when the scanner is opened with respect to the upper surface of the printer. In an unlocked position, the unlocking part presses a first end of the stopper to allow the scanner cover to be opened by separating the second end from the locking part when the scanner is closed with respect to the upper surface of the printer.

According to another aspect of the present invention, a central part of the stopper is coupled to the stopper accommodator to pivot between the locked position and the unlocked position as the scanner opens and closes the upper surface of the printer.

According to a further aspect of the present invention, the stopper has a shaft which is substantially parallel to an axis around which the scanner pivots with respect to the printer.

According to one more aspect of the present invention, the locking part comprises a locking groove, and the second end of the stopper is extended to be detachably attached to the locking groove.

According to yet another aspect of the present invention, the unlocking part comprises an unlocking groove with an angled surface, and the first end of the stopper is slid along the angled surface to be detachably attached from the unlocking groove as the scanner is opened and closed with respect to the upper surface of the printer.

According to a yet further aspect of the present invention, the multi-function device further comprises a spring to press the stopper from the unlocked position to the locked position.

According to yet one more aspect of the present invention, the stopper is accommodated in the stopper accommodator so that is can move up and down, and moves up and down between the locked position and the unlocked position as the scanner opens and closes with respect to the upper surface of the printer.

According to another aspect of the present invention, the stopper is accommodated in the stopper accommodator to turn with respect to an axis of upward and downward directions. The locking part comprises a locking hole with a locking opening that extends in a radial direction. The second end is accommodated in the locking hole to move up and down and pivot and comprises a locking bar extending in a radial direction to allow the second end to separate from the locking hole by passing through the locking opening. A rotational converter turns the stopper about the axis of the upward and downward directions to make the stopper turn between an unlocked angle position in which the locking bar can pass through the locking opening, and a locked angle position in which the locking bar cannot pass through the locking opening.

According to a further aspect of the present invention, the rotational converter comprises a guide pin provided in one of the stopper accommodator and the stopper, and a guide groove in the other one of the stopper accommodator and the stopper to guide the guide pin.

According to one more aspect of the present invention, the unlocking part comprises an unlocking projection that is projected from the upper surface of the printer.

According to yet another aspect of the present invention, the multi-function device further comprises a spring to press the stopper toward the unlocking part.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic view of a conventional multi-function device;

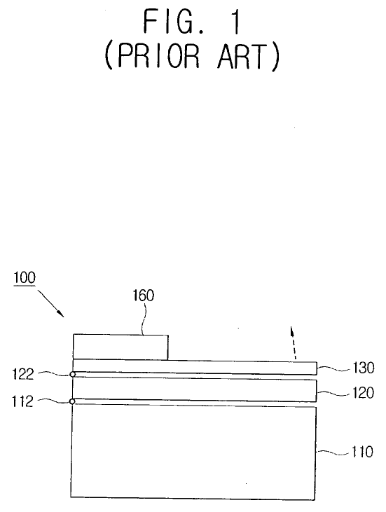

FIG. 2 is a schematic view of the multi-function device in FIG. 1, with the scanner and scanner cover in an opened position;

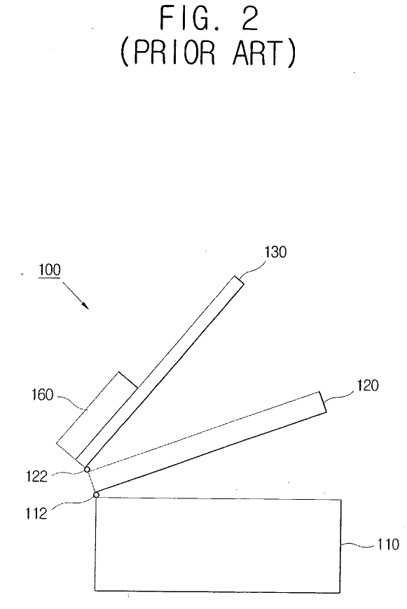

FIG. 3 is a schematic view of a multi-function device according to an exemplary embodiment of the present invention;

FIG. 4 is a schematic view of the multi-function device shown in FIG. 3;

FIG. 5 is a schematic view of a multi-function device according to another exemplary embodiment of the present invention;

FIG. 6 is a schematic view of the multi-function device shown in FIG. 5; and

FIG. 7 is a schematic view illustrating the operation of the multi-function device shown in FIG. 5.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

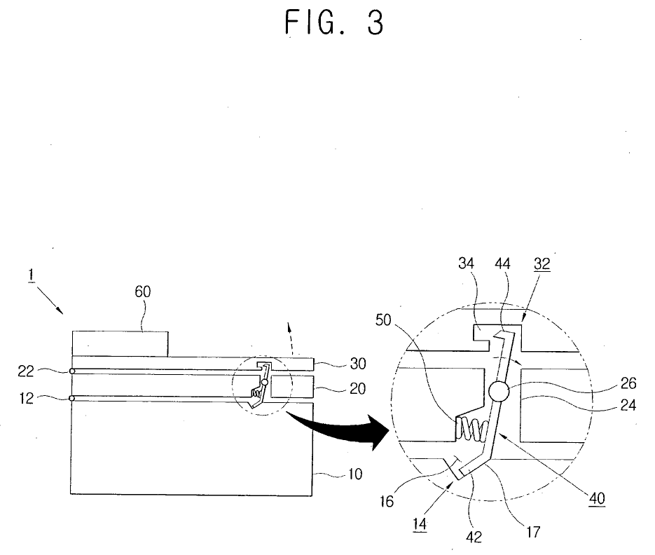

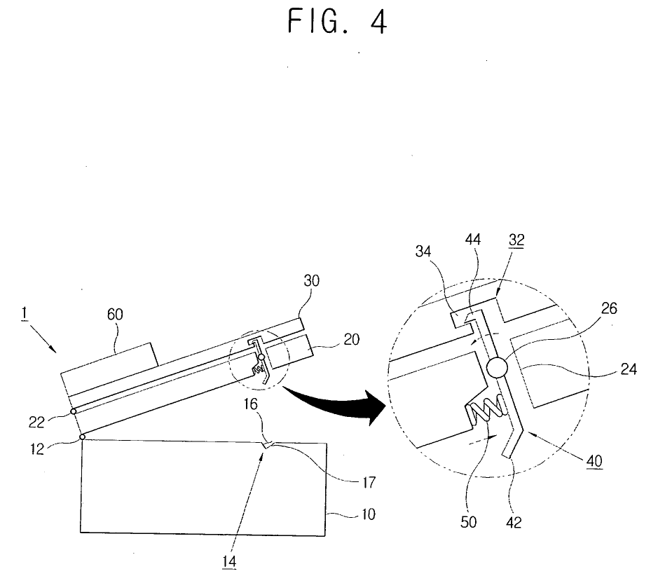

FIG. 3 illustrates a multifunction device where the scanner is closed with respect to a printer, and FIG. 4 illustrates the multifunction device where the scanner is opened with respect to the printer. As shown in those figures, a multi-function device 1 comprises a printer 10, a scanner 20 stacked on an upper part of the printer 10, a scanner cover 30 to open and close an upper surface of the scanner 20, and a stopper 40 to control the opening and closing of the scanner cover 30 according to the position of the scanner 20 (that is, whether the scanner is opened or closed with respect to the printer 10).

The printer 10 forms an image using a conventional printing method. Such methods include an ink jet method using a print head, a laser printing method using a photosensitive body, or any other similar method. The printer 10 receives image information from an external computer or the scanner 20 to form an image on a sheet of paper. The scanner 20 scans an image to store the image, to transmit the image information to an external computer (not shown), or to transmit the image information to the printer 10.

The scanner 20 is stacked on the upper part of the printer 10, and is coupled with the printer 10 by a first hinge 12 so that it can pivot to open or close the printer 10. The printer 10 is opened when servicing the printer, such as when replacing an ink cartridge or toner cartridge, or clearing a paper jam.

The scanner cover 30 is coupled to the scanner 20 by a second hinge 22 so that it can pivot to open and close the upper surface of the scanner 20. An upper unit 60 is attached to an upper part of the scanner cover 30. The upper unit 60 may comprise an automatic paper feeding unit or a unit to perform other functions. In the exemplary embodiment, the axis of the second hinge 22 is substantially parallel to the axis of the first hinge 12. Alternatively, the axis of the second hinge 22 may extend in a different direction than the axis of the first hinge 12. The first hinge 12 and the second hinge 22 may be formed in a single body.

The printer 10 has an unlocking part 14 formed with an unlocking groove 16. The unlocking groove 16 has an angled surface 17. The first end 42 of the stopper 40 slides along the angled surface 17 as the scanner 20 is opened and closed. The unlocking groove 16 may be formed on the upper surface, a lateral surface, or other positions of the printer 10. Alternatively, the unlocking groove 16 may be formed as part of the external housing of the printer 10 itself, as long as the first end 42 of the stopper 40 is detachable from the unlocking groove 16.

The scanner 20 comprises a stopper accommodator 24 to movably accommodate the stopper 40. The stopper accommodator 24 penetrates the scanner 20, preferably substantially vertically, thereby allowing the first end 42 and a second end 44 of the stopper 40 to contact the printer 10 and the scanner cover 30, respectively. The position of the stopper accommodator 24 is located so that it corresponds to the location of the unlocking groove 16. In other words, if the unlocking groove 16 is disposed on a central part of the printer 10, the stopper accommodator 24 penetrates a central part of the scanner 20, and if the unlocking groove 16 is disposed at an edge of the printer 10, the stopper accommodator 24 is formed at an edge of the scanner 20.

The scanner cover 30 includes a locking part 32 to detachably lock and support the second end 44 of the stopper 40. The locking part 32 is disposed on the central part or the edge of the scanner cover 30 so that it corresponds to the position of the stopper accommodator 24. The locking part 32 may be disposed on a lower or lateral part of the scanner cover 30. Alternatively, the locking part 32 may be formed as part of the housing of the scanner cover 30 itself, as long as the second end 44 is detachable.

The stopper 40 controls the pivoting of the scanner cover 30 as the scanner 20 is opened and closed. The stopper 40 is coupled with the stopper accommodator 24 by a shaft 26 in the stopper accommodator 24 so that the stopper 40 can pivot about the shaft 26. The first end 42 of the stopper 40 contacts the unlocking groove 16 when the scanner 20 is closed, and the second end 44 is locked in the locking part 32 when the scanner 20 is opened.

The stopper 40 is disposed in a locked position when the scanner 20 is opened to expose the upper surface of the printer 10. That is, the second end 44 of the stopper engages the locking part 32. Conversely, the stopper 40 is disposed in an unlocked position when the scanner 20 is closed with respect to the upper surface of the printer 10. That is, the second end 44 is separated from the locking part 32 because the unlocking part 14 presses the first end 42 of the stopper 40 to rotate the stopper 40. Accordingly, the stopper 40 moves according to the opening and closing of the printer 10 by the scanner 20, and pivots between the locked position and the unlocked position.

In the exemplary embodiment, the axis of the pivoting shaft 26 is substantially parallel to the axis of the first hinge 12. Thus, the stopper 40 pivots in the same direction as the scanner 20 opens and closes the upper surface of the printer 10. However, as long as the stopper 40 contacts the locking part 32 and the unlocking part 14, respectively, the axis of the pivoting shaft 26 may be formed in a different direction than the axis of the first hinge 12, thereby making the stopper 40 pivot in a different direction than the pivoting direction of the scanner 20.

The locking part 32 includes a locking groove 34 that extends in a circumferential direction of the shaft 26. The second end 44 of the stopper 40 extends in the circumferential direction of the shaft 26 to be detachably attached to the locking groove 34. When the stopper 40 is in the unlocked position, the second end 44 separates from the locking groove 34 and allows the scanner cover 30 to pivot. When the stopper 40 is in the locked position, an extended part of the second end 44 is locked into the locking groove 34, thereby preventing the scanner cover 30 from opening.

The angled surface 17 of the unlocking groove 16 is formed in the circumferential direction of the shaft 26 to conform to the direction where the first end 42 is detachably attached to the unlocking groove 16. As the scanner 20 opens and closes, the first end 42 of the stopper 40 is slid along the angled surface 17 of the unlocking groove 16.

A spring 50 is disposed between the stopper accommodator 24 and the stopper 40 and presses the stopper 40 in the circumferential direction to make the stopper 40 pivot from the unlocked position to the locked position, that is, to make the second end 44 remain supported by the locking groove 34. Alternatively, the spring 50 may be disposed between the shaft 26 and the stopper 40. The spring 50 may be a leaf spring or any other suitable spring.

The multi-function device 1 may include one locking set (that is, one set of unlocking part 14, stopper 40 and locking part 32) to control pivoting of the scanner cover 30, or it may include a plurality of locking sets. If two sets are provided, the second set is preferably disposed in the opposite side of the multi-function device 1 where the first hinge 12 is disposed.

Referring to FIGS. 3 and 4, the operation of the multi-function device according to the first exemplary embodiment of the present invention will be described. As shown in FIG. 3, when the scanner 20 is closed, the stopper 40 is pivoted into the unlocked position. The first end 42 engages the unlocking groove 16, and the second end 44 is separated from the locking groove 34. Accordingly, the scanner cover 30 can be easily opened and closed with respect to the upper surface of the scanner 20.

As shown in FIG. 4, if the scanner 20 is opened, the stopper 40 pivots into the locked position. The second end 44 of the stopper is coupled with the locking groove 34, due to the pressure of the spring 50, when the first end 42 is separated from the unlocking groove 16. The extended part of the second end 44 engages the locking groove 34, thereby preventing the scanner cover 30 from opening.

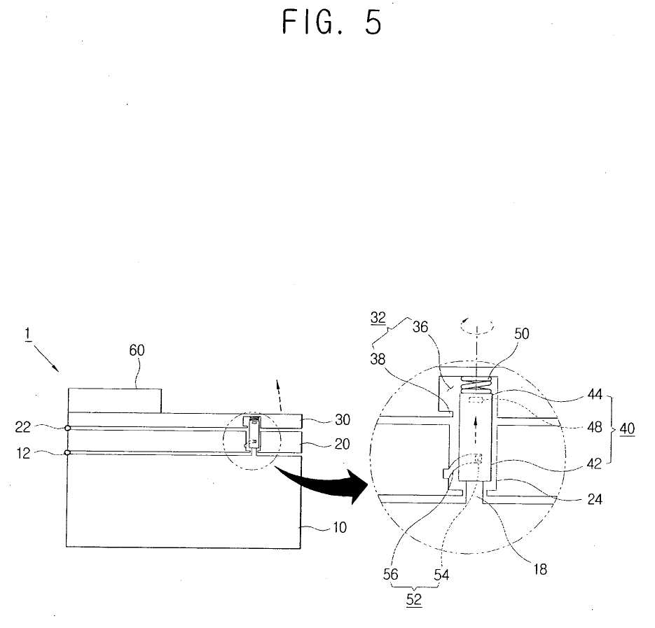

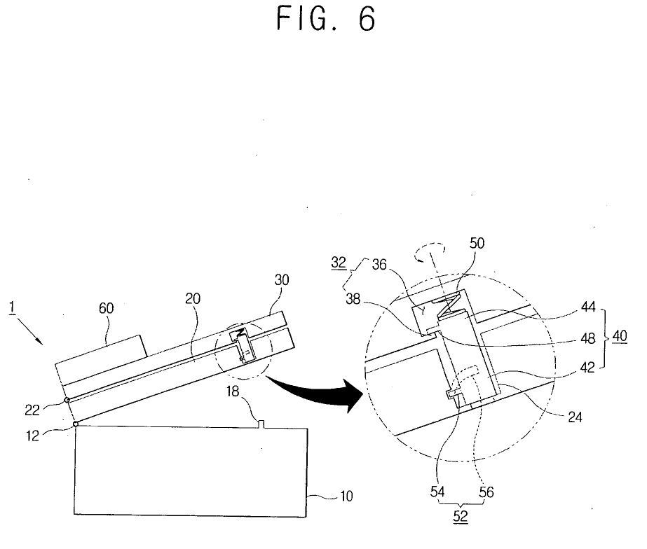

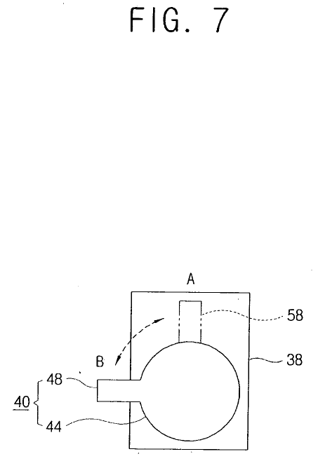

FIGS. 5, 6, and 7 illustrate another exemplary embodiment of the present invention. FIG. 5 illustrates the multifunction device with the scanner closed with respect to the printer, FIG. 6 illustrates the device with the scanner opened with respect to the printer, and FIG. 7 illustrates a stopper pivoting between a locked angle position and an unlocked angle position. As shown in those figures, a multi-function device 1 comprises a printer 10, a scanner 20, and a scanner cover 30. The printer has an unlocking projection 18, the scanner 20 has a stopper accommodator 24, and the scanner cover 30 has a locking part 32. A stopper 40 is accommodated in the stopper accommodator 24 so that it can move up and down and rotate about a vertical axis.

The printer 10 has an unlocking projection 18 that projects from an upper surface of the printer 10 to press a first end 42 of the stopper 40. Alternatively, the unlocking projection 18 may be formed on a lateral surface of the printer 10 or any other desired position. The unlocking projection 18 may be formed on the external housing of the printer as long as it presses the first end 42 of the stopper 40.

The scanner 20 has a stopper accommodator 24 to accommodate the stopper 40 so that it can move up and down and rotate. The stopper accommodator 24 may be disposed in a predetermined position in the scanner 20 as long as it corresponds to the position of unlocking projection 18. The stopper accommodator 24 vertically penetrates the scanner 20 to make opposite ends of the stopper 40 contact the unlocking projection 18 and the locking part 32 as the stopper 40 moves up and down.

The location of the locking part 32 in the scanner cover 30 corresponds to the location of the stopper accommodator 24 so that it can lock and support the second end 44 of the stopper. The locking part 32 comprises a locking hole 36 and a locking opening 38. The locking hole 36 accommodates the second end 44 of the stopper 40 so that it can move up and down and rotate. As seen in FIG. 7, the locking opening 38 has a slot 58 that extends a certain amount in a radial direction. A locking bar 48 of the second end 44 of the stopper 40 can pass through the locking opening 38 only when the locking bar is directed in the same direction as the slot 58. The locking opening 38 may have a single rectangular slot 58, or may have multiple openings that extend in multiple radial directions.

When the scanner 20 is closed, the locking projection 18 presses the first end 42 of the stopper 40 to move the stopper up within the stopper accommodator 24, placing the stopper 40 in the unlocked position. When the scanner 20 is opened, the unlocking projection 18 no longer presses the first end 42, so the stopper moves down within the stopper accommodator 24 into the locked position. Accordingly, the stopper 40 moves up and down corresponding to the opening and closing of the printer 10 by the scanner 20.

The spring 50 applies an elastic force to make the stopper 40 move from the unlocked position to the locked position when the scanner 20 opens the printer 10. The spring 50 may be disposed between the locking hole 36 and the second end 44. The spring 50 may also be disposed in any other suitable position. Further, the spring 50 may be omitted if the stopper 40 moves to the locked position by using its own weight or any other means.

The stopper 40 turns within the stopper accommodator 24 by a rotational converter 52 which converts the up and down movement of the stopper 40 into a rotational movement. The rotational converter 52 comprises a guide groove 56 and a guide pin 54. The guide groove 56 is formed on the internal surface of the stopper accommodator 24, and extends spirally along a lengthwise direction of the stopper accommodator 24. The guide pin 54 projects from an external surface of the stopper 40 and is guided by the guide groove 56. Alternatively, the guide groove 56 may be formed on the stopper 40, and the guide pin 54 may be formed on the stopper accommodator 24. The rotational converter 52 converts the up and down movement into a rotational movement.

The stopper 40 turns to an unlocked angle position (A) by the rotational converter 52 when it is moved up into the unlocked position, and turns to a locked angle position (B) by the rotational converter 52 when it is moved down into the locked position.

The second end 44 of the stopper 40 includes the locking bar 48 that extends in a radial direction. The locking bar 48 may be accommodated in the locking hole 36 so that it can move up and down, and pivot. The locking bar 48 is shorter than the length of locking slot 58 of the locking opening 38, and longer than the remaining diameter of the locking opening 38. Thus, the locking bar 48 passes through the locking opening 38 only when the stopper 40 is in the unlocked angle positions (A), and the second end 44 may move into and out of the locking hole 36. When the stopper 40 is in the locked angle position (B), the locking bar 48 is blocked by the locking opening 38, and the second end 44 may not move into and out of the locking hole 36.

The locking bar 48 may be formed so that its shape corresponds to the shape of the locking opening 38. If the locking opening 38 is rectangular, the locking bar 48 may extend in a single radial direction. If the locking opening 38 extends in plural directions, the locking bar 48 may extend in plural radial directions to conform to the directions of the locking opening 38.

Referring to FIGS; 5 to 7, the operation of the multi-function device according to this exemplary embodiment of the present invention will be described. As shown in FIG. 5, when the scanner 20 closes the printer 10, the unlocking projection 18 presses the first end 42, and the stopper 40 rises to the unlocked position. At the same time, the guide pin 54 moves spirally along the guide groove 56, and the stopper 40 turns to the unlocked angle position (A). Then, the locking bar 48 may pass through the locking opening 38, and the second end 44 may move into and out of the locking hole 36. Accordingly, the scanner cover 30 may be easily opened and closed.

As shown in FIG. 6, when the scanner 20 is opened, the first end 42 is withdrawn so that the unlocking projection 18 no longer presses the first end 42, and the stopper 40 moves to the locked position due to the force of the spring 50. At the same time, the stopper 40 turns to the locked angle position (B) by the rotational converter 52. The locking bar 48 is blocked by the locking opening 38 and the second end 44 may not be separated from the locking hole 36. Accordingly, the scanner cover 30 is prevented from opening.

While the invention has been shown and described with reference to certain embodiments thereof, it will be understood by those skilled in the art that various changes in form and details may be made therein without departing from the spirit and scope of the invention as defined by the appended claims.

What is claimed is:

1. A multi-function device comprising:
a printer comprising an unlocking part;
a scanner coupled to the printer so that it can be opened and closed with respect to an upper surface of the printer, and comprising a stopper accommodator penetrating the scanner at a position that corresponds to position of the unlocking part;
a scanner cover coupled to the scanner so that it can be opened and closed with respect to an upper surface of the scanner, and comprising a locking part in a position corresponding to the position of the stopper accommodator; and
a stopper movably accommodated in the stopper accommodator, the stopper having a first end that can contact the unlocking part and a second end that can be locked into the locking part, the stopper moving between a locked position in which the second end engages the locking part to prevent the scanner cover from being opened when the scanner is opened with respect to the upper surface of the printer, and an unlocked position in which the unlocking part presses the first end to allow the scanner cover to be opened by separating the second end from the locking part when the scanner is closed with respect to the upper surface of the printer.

2. The multi-function device according to claim 1, wherein
a central part of the stopper is rotatably coupled to the stopper accommodator so that it can move between the locked position and the unlocked position as the scanner opens and closes with respect to the upper surface of the printer.

3. The multi-function device according to claim 2, wherein
the scanner pivots around an axis with respect to the printer to open and close, and
the stopper comprises a shaft that is substantially parallel to the axis around which the scanner pivots with respect to the printer.

4. The multi-function device according to claim 3, wherein
the locking part comprises a locking groove, and
the second end of the stopper is extended to be engaged and disengaged with the locking groove.

5. The multi-function device according to claim 4, wherein
the unlocking part comprises an unlocking groove with an angled surface, and
the first end of the stopper is slid along the angled surface as the scanner opens and closes the upper surface of the printer.

6. The multi-function device according to claim 2, further comprising
a spring to press the stopper to make the stopper move from the unlocked position to the locked position.

7. The multi-function device according to claim 1, wherein
the stopper is accommodated in the stopper accommodator to move up and down, and moves up and down between the locked position and the unlocked position as the scanner opens and closes the upper surface of the printer.

8. The multi-function device according to claim 7, wherein
the stopper is accommodated in the stopper accommodator to rotate with respect to a vertical axis, and the locking part comprises a locking hole comprising a locking opening extending in a radial direction, and the second end is accommodated in the locking hole to move up and down and rotate and comprises a locking bar extending in a radial direction so that the second end can be separated from the locking hole by passing through the locking opening in the predetermined radial direction, and further comprising a rotational converter rotating the stopper between an unlocked angle position in which the locking bar is directed to the predetermined radial direction when the stopper moves to the unlocked position, and a locked angle position in which the locking bar is directed to another direction different from the predetermined radial direction when the stopper moves to the locked position.

9. The multi-function device according to claim 8, wherein the rotational converter comprises:
a guide pin provided in one of the stopper accommodator and the stopper; and
a spiral guide groove in the other one of the stopper accommodator and the stopper to guide the guide pin.

10. The multi-function device according to claim 9, wherein
the unlocking part comprises an unlocking projection that projects from the upper surface of the printer.

11. The multi-function device according to claim 7, further comprising:
a spring to press the stopper toward the unlocking part.

12. A locking device for preventing a scanner cover from opening in a multifunctional device that includes a printer, a scanner coupled to the printer by a hinge so that it can move between opened and closed positions, and a scanner cover coupled to the scanner by a hinge so that it can move between opened and closed positions, the locking device comprising:
an unlocking part disposed on the printer;
a locking part disposed on the scanner cover; and
a stopper having a first end and a second end, the stopper being disposed on the scanner to move between a locked position where the stopper engages the locking part to prevent the scanner cover from being opened and an unlocked position where the stopper is disengaged from the locking part so that the scanner cover can be opened.

13. A locking device according to claim 12, wherein
the unlocking part engages the first end of the stopper to move the stopper between the locked and unlocked positions, and
the second end of the stopper is engaged with the locking part in the locked position and disengaged from the locking part in the unlocked position.

14. A locking device according to claim 13, further comprising:
a stopper accommodator that penetrates the scanner and receives the stopper.

15. A locking device according to claim 14, wherein
the locking part has a locking groove, and
the second end of the stopper has an extended part that engages the locking groove to prevent the cover from opening.

16. A locking device according to claim 15, wherein
the unlocking part includes an angled surface that engages the first end of the stopper to move the stopper into the unlocked position.

17. A locking device according to claim 16, wherein
the stopper pivots about an axis that is substantially parallel to the axis of the hinge that connects the scanner to the printer.

18. A locking device according to claim 13, further comprising:
a stopper accommodator that penetrates the scanner in a substantially vertical direction, the stopper being rotatably received in the stopper accommodator so that the stopper can rotate about a substantially vertical axis.

19. A locking device according to claim 18, wherein
the locking part comprises a locking hole with a locking slot; and
the second end of the stopper has a locking bar that can move through the locking slot in the unlocked position, and the locking bar cannot move through the slot in the locked position.

20. A locking device according to claim 19, further comprising:
a rotational converter that rotates the stopper between the locked and unlocked positions.

21. A locking device according to claim 20, wherein the rotational converter comprises:
a guide pin disposed on one of the stopper accommodator or the stopper; and
a spiral guide groove disposed on the other one of the stopper accommodator or the stopper to guide the guide pin.
